(19) United States
(12) Patent Application Publication
(10) Pub. No.: US 2024/0094172 A1
(43) Pub. Date: Mar. 21, 2024

(54) METAL REINFORCED CRYOGENIC TRAP FOR THERMAL DESORBER

(71) Applicant: PERKINELMER U.S. LLC, Shelton, CT (US)

(72) Inventors: Samuel TOLLEY, Orem, UT (US); Chad KINGSTON, Saratoga Springs, UT (US)

(21) Appl. No.: 17/934,070

(22) Filed: Sep. 21, 2022

(51) Int. Cl. G01N 30/30

(52) U.S. Cl. CPC G01N 30/30; G01N 2030/025

(57) ABSTRACT

A cryogenic trap for a thermal desorber includes a hollow quartz tube having a tube wall, a tube inlet, a tube outlet, and an interior passageway between the tube inlet and the tube outlet. A sorbent material is within the interior passageway, and a metal covering surrounds at least a portion of the quartz tube. The metal covering may be a metallic coating on an outer surface of the tube wall or a metal tube fitted around the quartz tube. The metal covering may be around a portion of the quartz tube adjacent the tube inlet and/or around a portion of the quartz tube adjacent the tube outlet. The metal covering may be around substantially an entirety of the quartz tube.

### FIELD

The present inventive concept relates generally to thermal desorbers and, more particularly, to cryogenic traps for thermal desorbers.

### BACKGROUND

Gas chromatography is essentially a physical method of separation in which constituents of a vapor sample in a carrier gas are adsorbed or absorbed and then desorbed by a stationary phase material in a column. Interactions between this stationary phase material and the various components of the sample—which differ based upon differences among partition coefficients of the components—cause the sample to be separated into the respective components. At the end of the column, the individual components are more or less separated in time. Detection of the gas provides a time-scaled pattern, typically called a chromatogram, that, by calibration or comparison with known samples, indicates the constituents, and the specific concentrations thereof, which are present in the test sample.

Often, the analytes to be measured are retained by and concentrated on an adsorbent in a sample tube. Once the analytes are collected in the sample tube, the tube is then transported to a thermal desorption unit, where the tube is placed in the flow path of an inert gas, such as helium or nitrogen. The tube is subsequently heated, thereby desorbing the analytes, and the carrier gas sweeps the analytes out of the tube. In some cases, a trap is located downstream of the sample tube in order to further pre-concentrate the analytes, and occasionally, remove moisture therefrom, prior to introducing the sample into the chromatographic column. One example of such a trap is an adsorbent trap, usually cooled to a sub-ambient temperature, which may simply be another sorbent tube with a suitable adsorbent material. The adsorbent trap adsorbs the analytes as the sample gas first passes through the tube. The analytes are then subsequently desorbed into the chromatographic column from the trap, usually by heating, for subsequent separation and analysis as discussed above. Typically, either the column is directly coupled to a sorbent tube in the thermal desorption unit or the unit is connected directly to the column via a transfer line, such as, for example, via a length of fused silica tubing.

### SUMMARY

According to some embodiments of the present inventive concept, a cryogenic trap for a thermal desorber includes a hollow quartz tube having a tube wall, a tube inlet, a tube outlet, and an interior passageway between the tube inlet and the tube outlet; a sorbent material within the interior passageway; and a metal covering around at least a portion of the quartz tube. In some embodiments, the metal covering includes a nickel-cobalt ferrous alloy. In some embodiments, the metal covering is a metallic coating on an outer surface of the tube wall or a metal tube fitted around the quartz tube. In some embodiments, the metal covering is around a portion of the quartz tube adjacent the tube inlet and/or around a portion of the quartz tube adjacent the tube outlet. In some embodiments, the metal covering is around substantially an entirety of the quartz tube.

In some embodiments, the tube wall has a thickness of between about 0.5 mm and about 3 mm, and the metal covering has a thickness of between about 0.1 mm and about 0.5 mm. In some embodiments, the metal covering has a coefficient of thermal expansion that is substantially the same as the quartz tube. In some embodiments, the metal covering includes visible and/or machine readable indicia.

The metal covering is configured to provide increased mechanical strength to the quartz tube and to allow the cryogenic trap to withstand a rapid transition in temperature from about −100° C. to about 500° C. without degradation. The increased strength provided by the metal covering also facilitates installation of the cryogenic trap in a thermal desorber apparatus.

A first metal pneumatic fitting is secured to the tube inlet in direct contact with the metal covering, and a second metal pneumatic fitting is secured to the tube outlet in direct contact with the metal covering. The first and second pneumatic fittings are configured to allow a stream of gas to flow through the interior passageway. The metal covering facilitates the direct attachment of the pneumatic fittings to the tube without requiring the use of O-rings.

An inductive heater may be positioned in adjacent, spaced apart relationship with the metal covering. The inductive heater is configured to selectively heat the metal covering.

According to some embodiments of the present inventive concept, a cryogenic trap for a thermal desorber includes a hollow quartz tube having a tube wall, a tube inlet, a tube outlet, and an interior passageway between the tube inlet and the tube outlet; a sorbent material within the interior passageway; a metal coating on at least a portion of an outer surface of the tube wall; and a first metal pneumatic fitting secured to the tube inlet in direct contact with the metal coating, and a second metal pneumatic fitting secured to the tube outlet in direct contact with the metal coating, wherein the first and second pneumatic fittings are configured to allow a stream of gas to flow through the interior passageway. In some embodiments, the metal coating is on substantially an entirety of the outer surface of the tube wall.

The metal coating is configured to provide increased mechanical strength to the quartz tube and to allow the cryogenic trap to withstand a rapid transition in temperature from about −100° C. to about 500° C. without degradation. The increased strength provided by the metal coating also facilitates installation of the cryogenic trap in a thermal desorber apparatus.

In some embodiments, the metal coating includes visible and/or machine readable indicia. In some embodiments, the metal coating has a coefficient of thermal expansion that is substantially the same as the quartz tube.

An inductive heater may be positioned in adjacent, spaced apart relationship with the metal coating. The inductive heater is configured to selectively heat the metal coating.

According to some embodiments of the present invention, a cryogenic trap for a thermal desorber, the cryogenic trap includes a hollow quartz tube comprising a tube wall, a tube inlet, a tube outlet, and an interior passageway between the tube inlet and the tube outlet; a sorbent material within the interior passageway; a metal tube fitted around at least a portion of the quartz tube; and a first metal pneumatic fitting secured to the tube inlet in direct contact with the metal tube, and a second metal pneumatic fitting secured to the tube outlet in direct contact with the metal tube, wherein the first and second pneumatic fittings are configured to allow a stream of gas to flow through the interior passageway. In some embodiments, the metal tube is fitted around substantially an entirety of the quartz tube.

The metal tube is configured to provide increased mechanical strength to the quartz tube and to allow the cryogenic trap to withstand a rapid transition in temperature from about −100° C. to about 500° C. without degradation. The increased strength provided by the metal tube also facilitates installation of the cryogenic trap in a thermal desorber apparatus.

In some embodiments, the metal tube includes visible and/or machine readable indicia. In some embodiments, the metal tube has a coefficient of thermal expansion that is substantially the same as the quartz tube.

An inductive heater may be positioned in adjacent, spaced apart relationship with the metal tube. The inductive heater is configured to selectively heat the metal tube.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1 is a side view of a cryogenic trap, according to some embodiments of the present inventive concept.

FIG. 2 is a cross-sectional view of the cryogenic trap of FIG. 1 taken along line 2-2.

FIG. 3 is a cross-sectional view of the cryogenic trap of FIG. 1 taken along line 3-3. The contents of the cryogenic trap are illustrated in FIG. 3.

FIG. 4 is a side view of a cryogenic trap, according to some embodiments of the present inventive concept.

FIG. 5 is a cross-sectional view of the cryogenic trap of FIG. 4 taken along line 5-5. The contents of the cryogenic trap are not illustrated in FIG. 5 for clarity.

FIG. 6 illustrates the cryogenic trap of FIG. 1 with a metal pneumatic fitting secured to the tube inlet and a metal pneumatic fitting to the tube outlet.

FIG. 7 illustrates the cryogenic trap of FIG. 4 with a metal pneumatic fitting secured to the tube inlet and a metal pneumatic fitting to the tube outlet.

### DETAILED DESCRIPTION

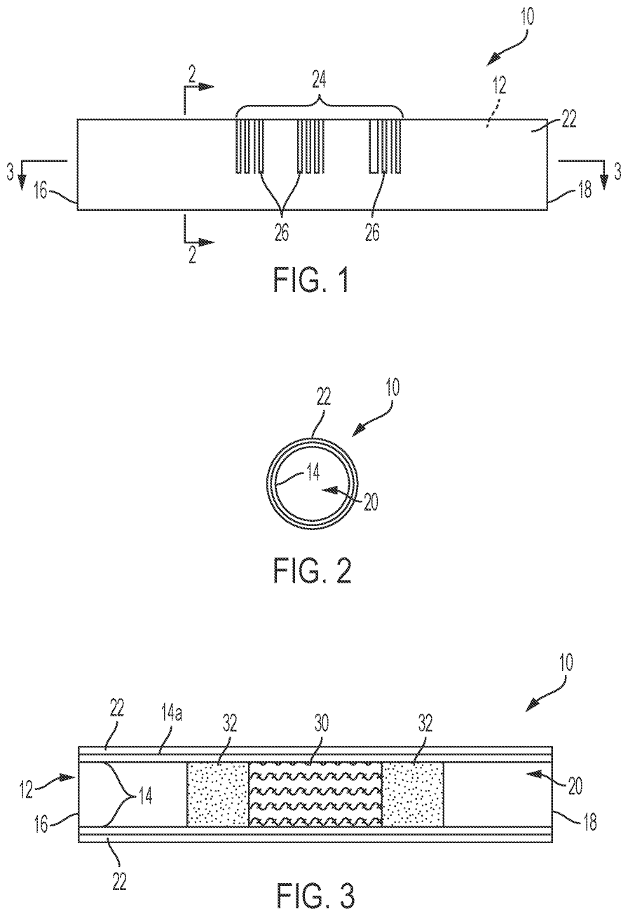

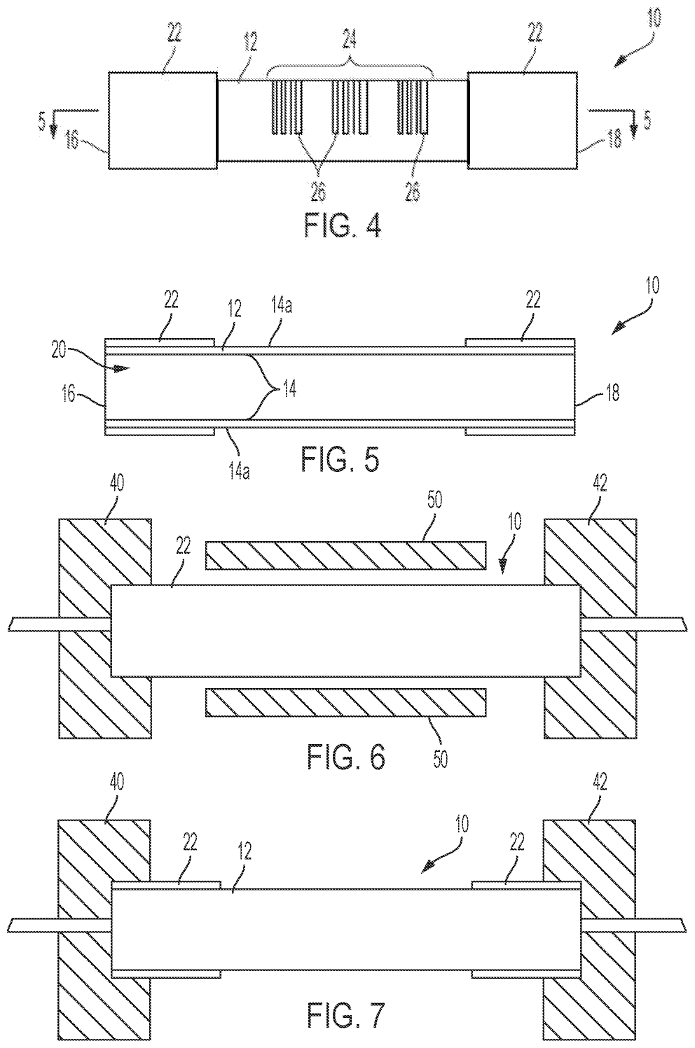

Referring initially to FIGS. 1-3, a cryogenic trap 10 for a thermal desorber, according to some embodiments of the present inventive concept, is illustrated. The cryogenic trap 10 includes a hollow quartz tube 12 having a tube wall 14, a tube inlet 16, a tube outlet 18, and an interior passageway 20 between the tube inlet 16 and the tube outlet 18. A metal covering 22 surrounds the quartz tube 12. In some embodiments, the metal covering 22 surrounds substantially the entire quartz tube 12. In other embodiments, the metal covering 22 may surround one or more portions of the quartz tube 12. For example, FIG. 1 illustrates the metal covering 22 surrounding substantially the entire quartz tube 12. FIGS. 4 and 5 illustrate a cryogenic trap 10 wherein a metal covering 22 surrounds the quartz tube 12 only adjacent the tube inlet 16 and the tube outlet 18.

The tube wall 14 typically has a thickness of between about 0.5 mm and about 3 mm; however, other thicknesses may be utilized. The metal covering 22 typically has a thickness of between about 0.1 mm and about 0.5 mm; however, other thicknesses may be utilized. It will be understood that the metal covering 22 and/or tube wall 14 are shown exaggerated in size relative to each other in the figures. For example, the metal covering 22 may be substantially thinner than the quartz tube wall 14 in some embodiments. In other embodiments, the quartz tube wall 14 may be substantially thinner than the metal covering 22. In other embodiments, the quartz tube wall 14 and the metal covering 22 may have substantially similar thicknesses.

Quartz tubes without a metallic coating are very fragile. As such, it is generally recommended to have spare quartz tubes on hand when replacing them in case of breakage during the replacement process. Using any force in installing a plain quartz tube may result in the tube breaking. Additionally, if not properly aligned in the system, a plain quartz tube may crack when it is secured into place at its points of connection. Moreover, a plain quartz tube may fracture if it is subject to bending or stress. The fragility of quartz tubes without a metallic covering 22, according to embodiments of the present invention, can lead to increased costs due to the need to replace broken tubes. A cracked or improperly installed quartz tube will cause the system to not work/function as intended. For example, the system may not properly cool, it may lead to inaccurate quantitation or misidentification, and/or it may cause a leak either along the length of the tube or at the points of connection. Furthermore, plain quartz tubes typically rely on soft O-ring connectors, which are expensive and degrade rapidly at the required operating temperatures and may leak, thereby decreasing the number of times they can be used.

The metal covering 22 is configured to provide increased mechanical strength to the quartz tube 12, which allows it to be more easily installed, removed, and replaced resulting in fewer user errors. The metal covering 22 is also configured to connect via pneumatic fittings 40, 42, for example, metal ferrules, which do not degrade at the rate that soft O-rings do and can be more cost-effective. Further, the metal covering 22 is configured to allow the cryogenic trap 10 to withstand a rapid transition in temperature from about −100° C. to about 500° C. without degradation. The increased strength provided by the metal covering 22 also facilitates installation of the cryogenic trap 10 in a thermal desorber apparatus.

In some embodiments, the metal covering 22 has a coefficient of thermal expansion that is substantially the same as the quartz tube 12. Typically, the metal covering 22 has a coefficient of thermal expansion that is substantially the same as the quartz tube 12 if the thicknesses of the tube wall 14 and the metal covering 22 are similar and greater than about 0.1 mm. However, in embodiments where the metal covering 22 is very thin compared to the thickness of the tube wall 14, the metal covering 22 does not need to have the same coefficient of thermal expansion as the quartz tube 12. Similarly, in embodiments where the tube wall 14 is very thin (e.g., about 0.003 inches) compared to the thickness of the metal covering 22, the metal covering 22 does not need to have the same coefficient of thermal expansion as the quartz tube 12. An exemplary length of the quartz tube 12 is about 5.25 inches, although other lengths may be utilized. An exemplary diameter of the quartz tube 12 is about 0.125 inch, although other diameters may be utilized.

In some embodiments, the metal covering 22 is formed from a nickel-cobalt ferrous alloy, such as KOVAR®, which has a coefficient of thermal expansion that is similar to borosilicate glass and quartz. However, other metals and alloys may be utilized, such as, for example, aluminum, nickel, and stainless steel.

In some embodiments, the metal covering 22 is a metallic coating on an outer surface 14a of the tube wall 14. In other embodiments, the metal covering 22 is a metal tube fitted around the quartz tube 12. As illustrated in FIGS. 4 and 5, the metal covering may be located around a portion of the quartz tube 12 adjacent the tube inlet 16 and/or around a portion of the quartz tube 12 adjacent the tube outlet 18. The contents of the interior passageway 20 of the quartz tube 12 in FIG. 5, such as sorbent material and retention material, are not illustrated for clarity. However, it is to be understood that the interior passageway 20 of the quartz tube 12 in FIG. 5 may contain sorbent material and retention material, as illustrated in the tube 12 of FIG. 3.

In some embodiments, the metal covering 22 and/or the quartz tube 12 may include visible and/or machine readable indicia 24. In some embodiments, the visible and/or machine readable indicia 24 is a barcode including a plurality of indicia bars 26 distributed along a portion of the quartz tube 12 (FIG. 4) or a portion of the metal covering 22 (FIG. 1). The barcode (or other visible indicia) may be formed of any suitable material(s) and may be secured to the quartz tube 12 or metal covering 22 by any suitable technique. In some embodiments, the barcode 26 is permanently located (i.e., secured or formed) on the quartz tube 12 or metal covering 22. In some embodiments, the barcode 26 is permanently embossed or etched into a surface (e.g., the outer surface) of the quartz tube 12 or metal covering 22. In some embodiments, the barcode 26 is printed (and, in some embodiments, permanently printed) on a surface (e.g., the outer surface) of the quartz tube 12 or metal covering 22.

A sorbent material 30 may be located within the interior passageway 20. An analyte or sample to be desorbed and analyzed may be present (e.g., adsorbed) on and/or in the sorbent material 30. Retention media 32 may be located in the interior passageway 20 on one or both ends of the sorbent material 30 to inhibit movement of the sorbent material 30 within the interior passageway 20. The sorbent material 30 may be formed of any suitable material(s). In some embodiments, the sorbent material 30 is formed of activated carbon. The retention media 32 may be formed of any suitable material(s). In some embodiments, the retention media 32 is formed of materials such as, but not limited to, unsilanized glass wool, glass wool, or quartz wool.

In use, a first metal pneumatic fitting 40 (e.g., a metal ferrule) is secured to the tube inlet 16 in direct contact with the metal covering 22, and a second metal pneumatic fitting 42 (e.g., a metal ferrule) is secured to the tube outlet in direct contact with the metal covering 22, as illustrated in FIGS. 6 and 7. The first and second pneumatic fittings 40, 42 are configured to allow a stream of gas to flow through the interior passageway 20, as would be understood by one of skill in the art. The metal covering 22 facilitates the direct attachment of the pneumatic fittings 40, 42 to the tube 12 without requiring the use of O-rings.

An inductive heater 50 may be positioned in adjacent, spaced apart relationship with the metal covering 22, as illustrated in FIG. 6. In some embodiments, the inductive heater 50 may surround one or more portions of the metal covering 22. The inductive heater 50 is configured to selectively heat the metal covering 22, which then heats the quartz tube 12 and the material therewithin.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

That which is claimed is:

1. A cryogenic trap for a thermal desorber, the cryogenic trap comprising:
a hollow quartz tube comprising a tube wall, a tube inlet, a tube outlet, and an interior passageway between the tube inlet and the tube outlet;
a sorbent material within the interior passageway; and
a metal covering around at least a portion of the quartz tube.

2. The cryogenic trap of claim 1, wherein the metal covering comprises a nickel-cobalt ferrous alloy.

3. The cryogenic trap of claim 1, wherein the metal covering comprises a metallic coating on an outer surface of the tube wall or a metal tube fitted around the quartz tube.

4. The cryogenic trap of claim 1, wherein the metal covering is around a portion of the quartz tube adjacent the tube inlet and/or around a portion of the quartz tube adjacent the tube outlet.

5. The cryogenic trap of claim 1, wherein the metal covering is around substantially an entirety of the quartz tube.

6. The cryogenic trap of claim 1, further comprising a first metal pneumatic fitting secured to the tube inlet in direct contact with the metal covering, and a second metal pneumatic fitting secured to the tube outlet in direct contact with the metal covering, wherein the first and second pneumatic fittings are configured to allow a stream of gas to flow through the interior passageway.

7. The cryogenic trap of claim 1, wherein the tube wall has a thickness of between about 0.5 mm and about 3 mm, and wherein the metal covering has a thickness of between about 0.1 mm and about 0.5 mm.

8. The cryogenic trap of claim 1, further comprising an inductive heater in adjacent, spaced apart relationship with the metal covering, wherein the inductive heater is configured to selectively heat the metal covering.

9. The cryogenic trap of claim 1, wherein the metal covering is configured to provide increased mechanical strength to the quartz tube and to allow the cryogenic trap to withstand a rapid transition in temperature from about −100° C. to about 500° C. without degradation.

10. The cryogenic trap of claim 1, wherein the metal covering comprises visible and/or machine readable indicia.

11. The cryogenic trap of claim 1, wherein the metal covering has a coefficient of thermal expansion substantially the same as the quartz tube.

12. A cryogenic trap for a thermal desorber, the cryogenic trap comprising:
a hollow quartz tube comprising a tube wall, a tube inlet, a tube outlet, and an interior passageway between the tube inlet and the tube outlet;
a sorbent material within the interior passageway;
a metal coating on at least a portion of an outer surface of the tube wall; and
a first metal pneumatic fitting secured to the tube inlet in direct contact with the metal coating, and a second metal pneumatic fitting secured to the tube outlet in direct contact with the metal coating, wherein the first and second pneumatic fittings are configured to allow a stream of gas to flow through the interior passageway.

13. The cryogenic trap of claim 12, wherein the metal coating is on substantially an entirety of the outer surface of the tube wall.

14. The cryogenic trap of claim 12, wherein the metal coating is configured to provide increased mechanical strength to the quartz tube and to allow the cryogenic trap to withstand a rapid transition in temperature from about −100° C. to about 500° C. without degradation.

15. The cryogenic trap of claim 12, further comprising an inductive heater in adjacent, spaced apart relationship with the metal coating, wherein the inductive heater is configured to selectively heat the metal coating.

16. The cryogenic trap of claim 12, wherein the metal coating comprises visible and/or machine readable indicia.

17. A cryogenic trap for a thermal desorber, the cryogenic trap comprising:
a hollow quartz tube comprising a tube wall, a tube inlet, a tube outlet, and an interior passageway between the tube inlet and the tube outlet;
a sorbent material within the interior passageway;
a metal tube fitted around at least a portion of the quartz tube; and
a first metal pneumatic fitting secured to the tube inlet in direct contact with the metal tube, and a second metal pneumatic fitting secured to the tube outlet in direct contact with the metal tube, wherein the first and second pneumatic fittings are configured to allow a stream of gas to flow through the interior passageway.

18. The cryogenic trap of claim 17, wherein the metal tube is fitted around substantially an entirety of the quartz tube.

19. The cryogenic trap of claim 17, wherein the metal tube is configured to provide increased mechanical strength to the quartz tube and to allow the cryogenic trap to withstand a rapid transition in temperature from about −100° C. to about 500° C. without degradation.

20. The cryogenic trap of claim 18, further comprising an inductive heater in adjacent, spaced apart relationship with the metal tube, wherein the inductive heater is configured to selectively heat the metal tube.
